(19) United States
(12) Patent Application Publication
(10) Pub. No.: US 2011/0302613 A1
(43) Pub. Date: Dec. 8, 2011

(54) SYSTEM AND METHOD TO CROP, SEARCH AND SHOP OBJECT SEEN ON A MOTION PICTURE

(76) Inventor: Shailesh Joshi, Karnatakka (IN)

(21) Appl. No.: 13/121,437

(22) PCT Filed: Sep. 29, 2008
(86) PCT No.: PCT/IN2008/000625

§ 371 Date: Aug. 5, 2011

(30) Foreign Application Priority Data
Sep. 27, 2007 (IN) 2042

(51) Int. Cl. H04N 21/254; H04N 21/478

(52) U.S. Cl. 725/60

(57) ABSTRACT

(EN) An interactive system and method to crop, search and shop object seen over an electronic media is provided. The system comprising, an electronic display media (103) a remote control device (102), a set-top box (103) a system server (106) capable to detect a response to a interactive information received from a user's terminal, a cable/MSO server (105) and search server (102) coupled to the system server (106), a shopping establishment network (108) coupled to the system server (106), a payment gateway (108) coupled to the system server (106). Also provided an interactive method to crop, search and shop object as displayed in an electronic media, the method comprising the steps of detecting an interactive visual displayed over an electronic media, selecting the desired visual, pausing the desired visual to create a still image, selecting the desired object as displayed in the still image, cropping the desired object, sending the selected information of the object for search of relevant information, retrieving the relevant information about the searched object, providing the retrieved information in a preferential mode

### CROSS REFERENCE TO RELATED APPLICATION

This application is related to Indian Provisional Patent Application No. 2042/DEL/2007 filed on Sep. 27, 2007. The entire contents of which are incorporated herein by this reference. The applicant hereby claims the benefit of this earlier pending provisional application.

### FIELD OF INVENTION

The present invention relates to an interactive system and method to crop, search and shop object seen over an electronic media, and in particular but not exclusively, relates to fulfillment of responses to advertisements relayed over a communication system, such as an interactive electronic media.

### BACKGROUND OF THE INVENTION

The survival of a television media is heavily dependent on the advertising revenue that can be realized form the television programs. The ubiquitous television commercial is the manifestation of this enterprise. Advertisers in turn rely on the ability of the television program to draw viewers who then become potential purchasers of the advertised products. An effective commercial is one that captures the viewer's attention in a lasting manner and that ultimately results in the purchase of goods and/or services. There are times when we see a particular object in a commercial advertisement on a television media and instantly desire to have the exact object in our possession. There are numerous occasion when we go out hunting for a particular cloth of a particular color as worn by an actor or actress as seen in a television program or commercial advertisement. There are instances when one likes to know more about a particular model of cell phone as displayed in a commercial advertisement on electronic media.

Such advertisements however make it inconvenient to potential customers to respond to advertisements, thereby ultimately reducing the customers' inclination to begin or complete a purchase.

Accordingly, improvements are needed in the user's disposal to advertisement of products and in the fulfillment of user responses to the advertisements.

### SUMMARY AND OBJECT OF THE INVENTION

Briefly, one exemplary embodiment relates to an interactive system to crop, search and shop object as displayed in an electronic media, the system comprising, an electronic display media, a remote control device, a set-top box, a system server capable to detect a response to an interactive information received from a user's terminal, a cable/MSO server and search server coupled to the system server, a shopping establishment network coupled to the system server, a payment gateway coupled to the system server.

Another exemplary embodiment relates to an interactive method to crop, search and shop object as displayed in an electronic media, the method comprising the steps of detecting an interactive visual displayed over an electronic media, selecting the desired visual, pausing the desired visual to create a still image, selecting the desired object as displayed in the still image, cropping the desired object, sending the selected information of the object for search of relevant information, retrieving the relevant information about the searched object, providing the retrieved information in a preferential mode.

Another exemplary embodiment relates to an interactive method to crop, search and shop object as displayed in an electronic media, the method comprising the steps of displaying the available retrieved options to the user, providing interactive options to purchase and/or store the selected information for future retrieval, providing options to ascertain the payment mode if user selects to purchase the desired object, generating a transaction ID and forwarding the purchase order to relevant and/or selected commercial establishment, notifying the user of all the relevant transaction information on the display screen and/or on a device registered with the system.

The object of the present invention is to provide an interactive system and method to pick/crop the objects a user can view in an electronic media like television.

Yet another object of to provide a system and method that refines the image of the object so cropped.

Yet another object of the instant invention is, to transmit this image to a server capable of conducting an image search of the object so selected.

Yet another object of the instant invention is to receive the information from the server and display it to the user.

Yet another object of the instant invention is to provide a system and a method to enable the user to buy the object.

Yet another object of the instant invention is to save the objects and the information for later use.

### BRIEF DESCRIPTION OF ACCOMPANYING DRAWINGS

Non-limiting and non-exhaustive features of the present invention together with its objects and advantages are described with reference to the accompanying drawings, like reference numerals refer to like elements throughout the various figures unless otherwise specified and wherein:

FIG. 1 illustrates the flow diagram of the interactive method to crop, search and shop object as displayed in an electronic media according to a preferred embodiment of the present invention.

FIG. 2 illustrates the preferred environment and elements of the present invention in which it works.

FIG. 3 illustrates the essential elements of the interactive system to crop, search and shop object as displayed in an electronic media according to a preferred embodiment of the present invention.

FIG. 4 illustrates the essential elements of a remote control device according to a preferred embodiment of the present invention.

FIG. 5 illustrates a user interface depicting various types of information as per the selection and/or choice of information by the user in a preferred embodiment of the present invention.

FIG. 6 illustrates a user interface depicting various types of information as per the selection and/or choice of information by the user in a preferred embodiment of the present invention.

FIG. 7 illustrates a user interface depicting various types of information as per the selection and/or choice of information by the user in a preferred embodiment of the present invention.

FIG. 8 illustrates the essential elements of a set-top box according to a preferred embodiment of the present invention.

FIG. 9 illustrates the essential elements of a system server according to a preferred embodiment of the present invention.

FIG. 10 illustrates the essential elements of a cable/MSO server, search server, payment gateway, shopping establishment network according to a preferred embodiment of the present invention.

FIG. 11 illustrates the flow diagram of the interactive method to crop, search and shop object as displayed in an electronic media according to a preferred embodiment of the present invention.

FIG. 12 illustrates the flow diagram of the interactive method to crop, search and shop object as displayed in an electronic media according to a preferred embodiment of the present invention.

FIG. 13 illustrates the flow diagram of the interactive method to crop, search and shop object as displayed in an electronic media according to a preferred embodiment of the present invention.

### DETAILED DESCRIPTION OF THE INVENTION

The present invention comprises an interactive system and method to crop, search and shop object seen over an electronic media.

In the following description for purposes of explanation, specific details are set forth in order to provide a thorough understanding of the present invention. It will be evident, however, to one skilled in the art that the present invention may be practiced without these specific details. In other instances, well known methods, procedures, components and circuits have not been described in detail so as not to obscure the present invention.

The present invention now will be described more fully hereinafter with reference to the accompanying drawings, which form a part hereof, and which show, by way of illustration, specific exemplary preferred embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

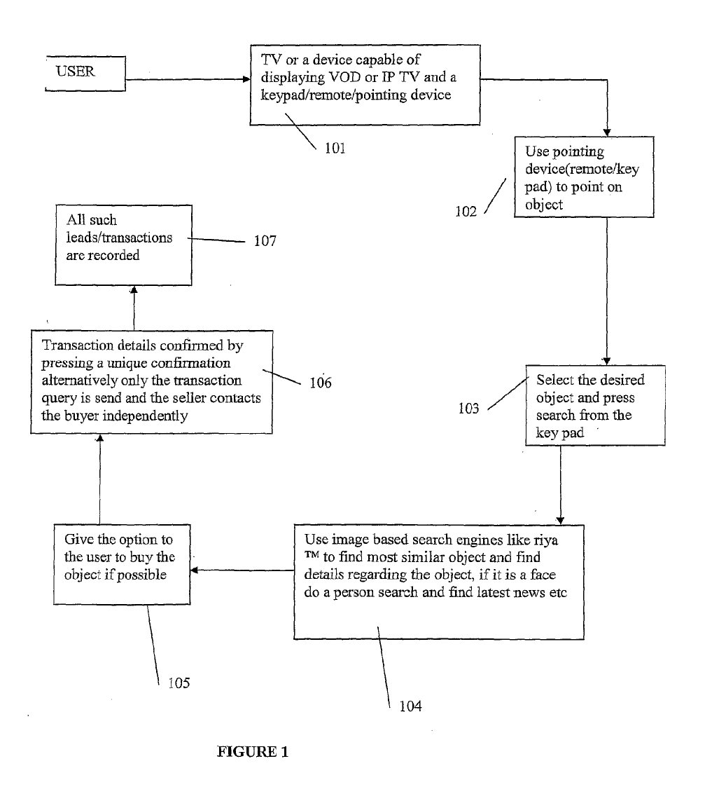

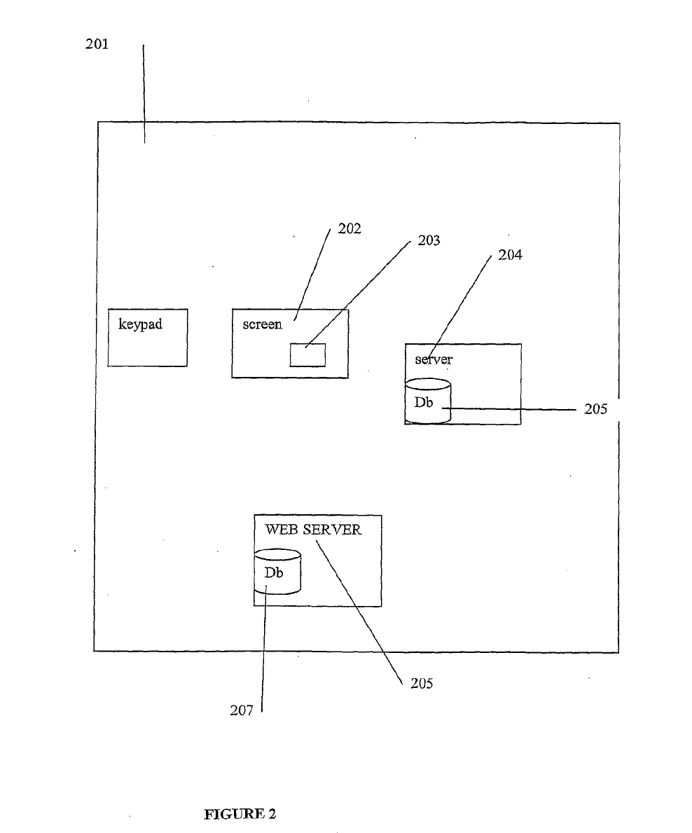

According to the preferred embodiment of the present invention, as shown by FIGS. 1 and 2 a user may view digital content on a device (202) capable of displaying video on demand (VOD) of Internet Protocol television (IP TV) (201) or an Internet enabled viewing device, wherein user may decide to get more information about a particular object. The user may freeze the motion picture using keypad/remote (201). The user may then use a pointed device which includes the keypad/remote to select a portion of the picture (102), the object is then allowed to be optionally edited and fine tuned. The interactive method also allows the user to save the object and/or information so selected for later reference to search for details. If the user opts to search (103), the system transmits the image to a Web Based search engine. The interactive method may use the images based search engine (104) to search for the details of the object so selected. The results of the same are shown to the user. At the instance of the user a user may conduct further search to get more information about the object of even but the object. If the user opts to buy (105) the object the user is given an option to either conduct the transaction using a unique key provided to the user or using if the user opts to transact otherwise, the query is forwarded to relevant service providers to enable the transaction (106). All such leads/transactions are stored by the web server that enable as well as optionally by the set top box that enables VOD an IPTV (107).

The searched and/or retrieved information as displayed on electronic device 202 is stored in the database 204 of the server 205. The content extracted from the Internet is stored in the database 207 of the web server 207.

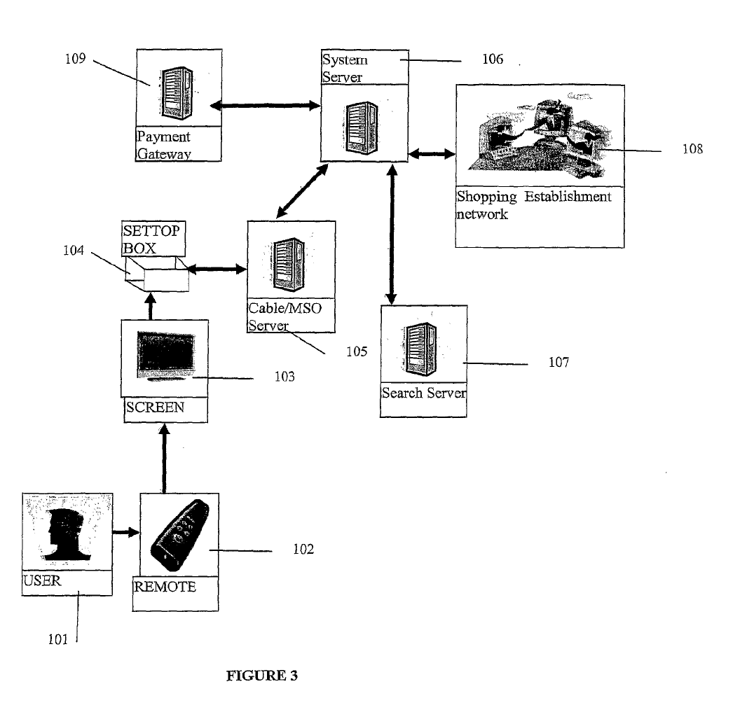

Referring to FIG. 3 which illustrates the essential elements of the interactive system to crop, search and shop object as displayed in an electronic media according to a preferred embodiment of the present invention. An interactive system to crop, search and shop object as displayed in an electronic media is provided wherein the system comprises an electronic display media 103, a remote control device 102, a set-top box 104, a system server 106 capable to detect a response to an interactive information received from a user's terminal, a cable/MSO server 105 and search server 107 coupled to the system server 106, a shopping establishment network 108 coupled to the system server 106, a payment gateway 109 coupled to the system server 106.

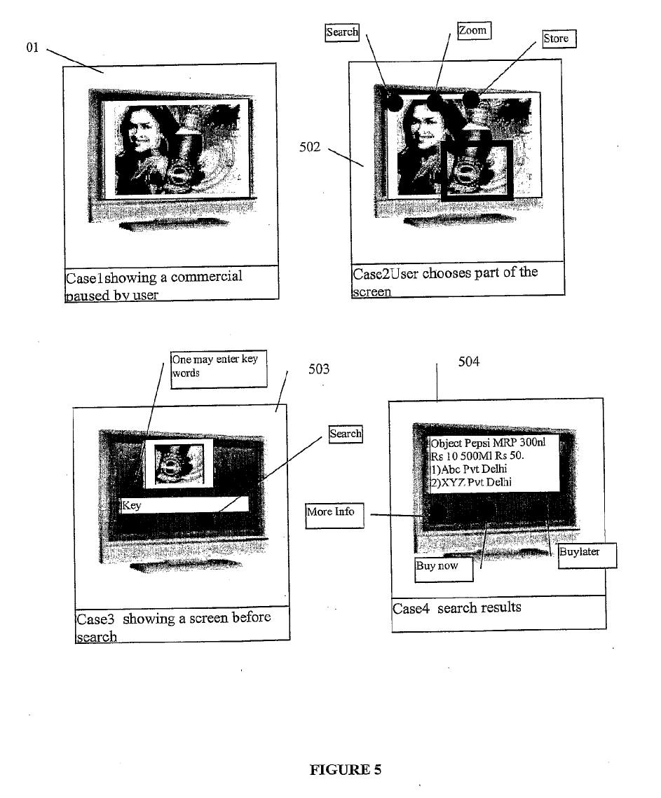

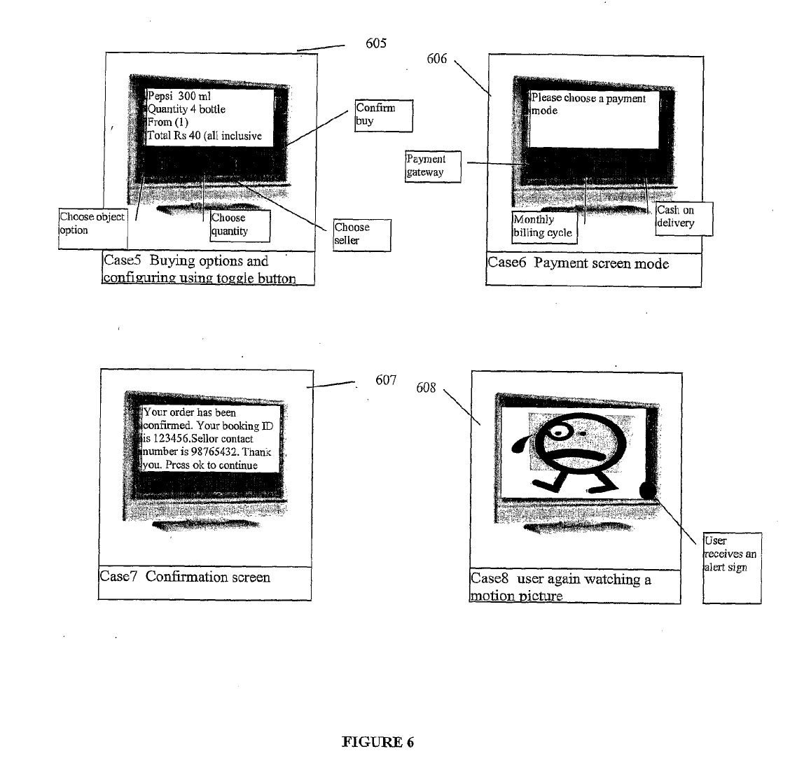

The interactivity to the user (101) is provided by the use of a remote control device (102). The various options available for interactivity and the effect of such interactivity can be seen on the display screen (103). This display screen is capable of displaying digital motion and still pictures. For a better understanding, reference will now be also made to FIGS. 5, 6, and 7 the display screen responds to the various kind of information request given to the system and provides a user interface depicting changes based on user requests. Say for example the screen may look like case 1 (501) when the user selects to pause the screen, Case 2(502) which illustrates the screen when the user chooses to crop a part of the paused image. It illustrates a cropping window. It also depicts illustrative buttons such as search, zoom and store that enable various functions. The user can choose any of these functions after the user has selected the area that needs to be cropped. Case 3(503) illustrates a screen when the user chooses to search. In such a case the user may optionally be provided a user interface to enter keywords related to the cropped image. Once the search option is chosen the request of such a request is forwarded to the system server 106 and from there to at least one Search Server (107). The results so received are presented to the user as shown in Case 4(504). The user is further provided options to buy a product, save the result or get more information about the combination of keywords and picture entered earlier.

Incase the user chooses to buy, the user is provided with an interface to choose the product and its quantity (605). The billing details of the user are taken from the MSO server 105) (cable operator server) which maintains a database of addresses where different set-top boxes with unique IDs are installed.

The user is further provided with different payment modes (606) and based on the choices of the user the transaction is connected relevant shopping establishment chosen from the shopping establishment network (108) and payment gateway (109). The shopping establishment receives the order and details about the payment method. If payment has already been made the shopping establishment receives a confirmation regarding the same too to the relevant payment gateway (109). A similar confirmation is also shown to the user (607). The user may then continue to watch the motion picture (608), while the user have the privilege to continue watching the motion picture, the system may send alerts to the set-top box (104). These alerts shall basically inform and update the user about the users' order. These updates shall reside as an icon on the side of the screen and can be accessed anytime at the instance of the user as shown in Case8(708). Similarly the user may'access the saved imaged, searches and tags anytime using the user friendly menu (709) that accepts and responds to user interrupts.

The cropped image may be zoomed and viewed by the viewer for closer look and new cropping as illustrated in case10(710).

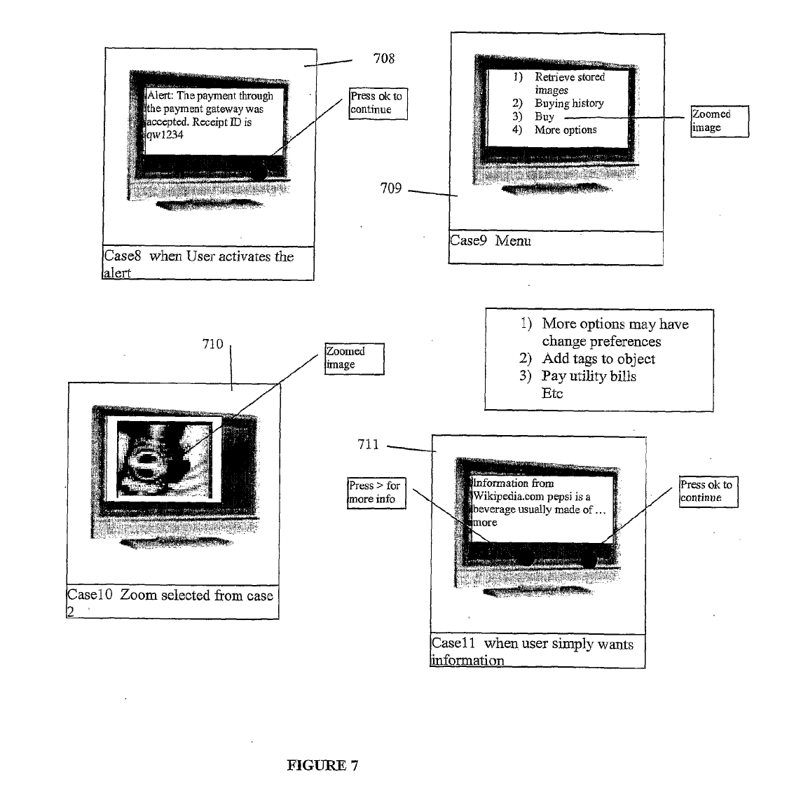

In-case the cropped object is not a product or incase the user defines that the user is only interested information about an object; the same is traversed and collected by the Search Server (107), processed by the system server (106) and shown the user on the display screen (103) as illustrated in FIG. 7. For example say the user crops ‘pepsi’ logo or icon and searches for it, the user is not only shown different options of purchase (results from the search server), the user is also shown the various shopping establishment providing delivery of the same.

Thus this shall enable and promote instant buying. The shopping establishment network on receiving the request of a product determines the possible sellers. The system server determines the order in which such sellers are to be presented to the user.

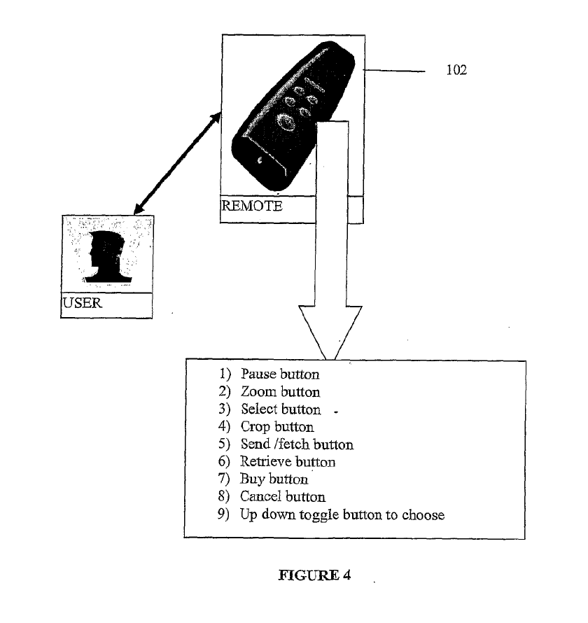

FIG. 4 illustrates the essential elements of a remote control device 102 according to a preferred embodiment of the present invention, wherein the remote control device 102 comprises, means to pause an image/visual selected by the user, means to zoom the image/visual selected by the user, means to choose the image/visual selected by the user, means to crop the image/visual selected by the user, means to send/fetch the information for the image/visual selected by the user, means to retrieve the information of the image/visual selected by the user, means to initiate the purchase on the basis of the image/visual selected by the user, means to cancel/continue the purchase according to user's preferences.

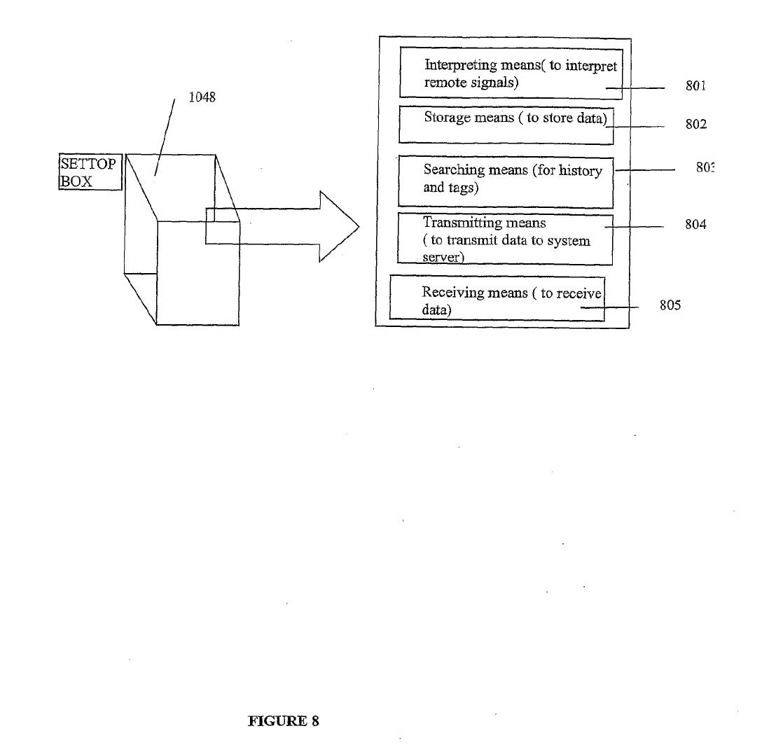

FIG. 8 illustrates the essential elements of a set-top box according to a preferred embodiment of the present invention wherein the set-top box comprises interpreting means to interpret remote signals 801, storage means to store data/information 802, searching means for the object selected by the user according to user's preferences 803, transmitting means to transmit data/information to system server 804, receiving means to receive data/information 805.

The picture so mentioned need not be one broadcasted and received through the set-top box. In one of the preferred embodiments it could also be from an external source like a Digital video player and like. I such a case the remote controlled device may be compatible with both set-top box and the player for easy navigation.

It is further connected to a device that provides a single feed to the display screen. This device may be a set-top box(103). This set-top box is capable of receiving interactive communication signals as sent by the remote (102). Accordingly the set-top box has interpreting means(801) to interpret signals received from the remote controlled device and interpret the received signals from the MSO server(105). This device (set-top box) further contains storage means(802) to store data, searching and sorting means(803) to enable search on previous history, tagging means to tag and store searched items. In one the preferred embodiment of the instant invention the system contains predictive means, to predict a result from the past history. In one the preferred embodiment of the instant invention the system may also contain suggestive means, to suggest a product(based on history and data received from the system server). These predictive and suggestive means reside either on the set-top box or on the system server(106). The set-top box also has transmitting means(804) to communicate with the system server.

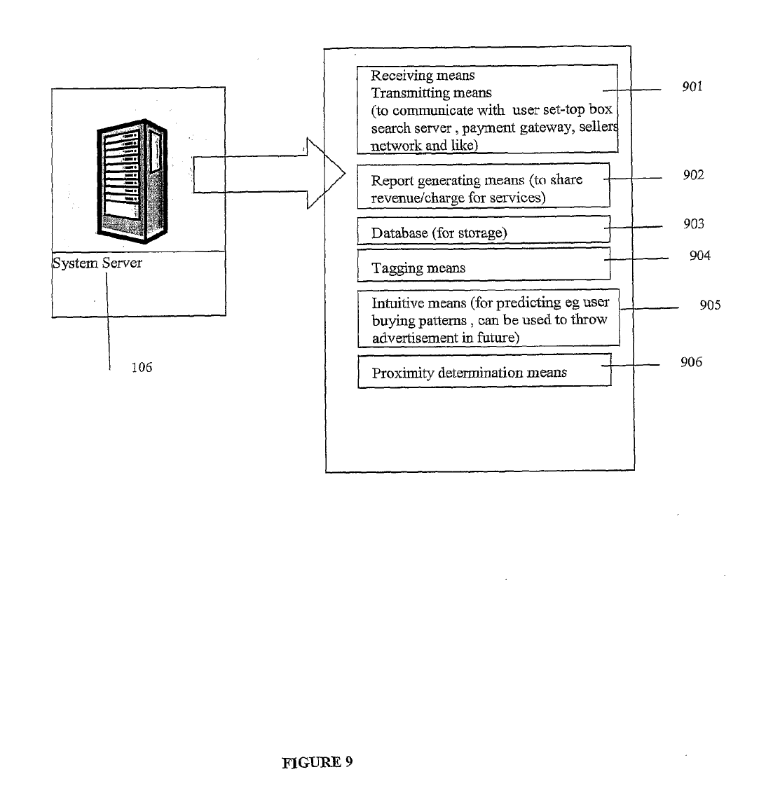

FIG. 9 illustrates the essential elements of a system server according to a preferred embodiment of the present invention wherein the system server comprises receiving and transmitting means to communicate with user set-top box, search server, payment gateway, shopping establishment gateway and the like 901, report generating means for transaction information of the selected object 902, database for storage of information relating to the transaction 903, tagging means to identify the object selected by the user 904, intuitive means for purchase and/or market prediction 905, proximity determination means 906 to provide the relevant information of the commercial establishments having the object selected by the user.

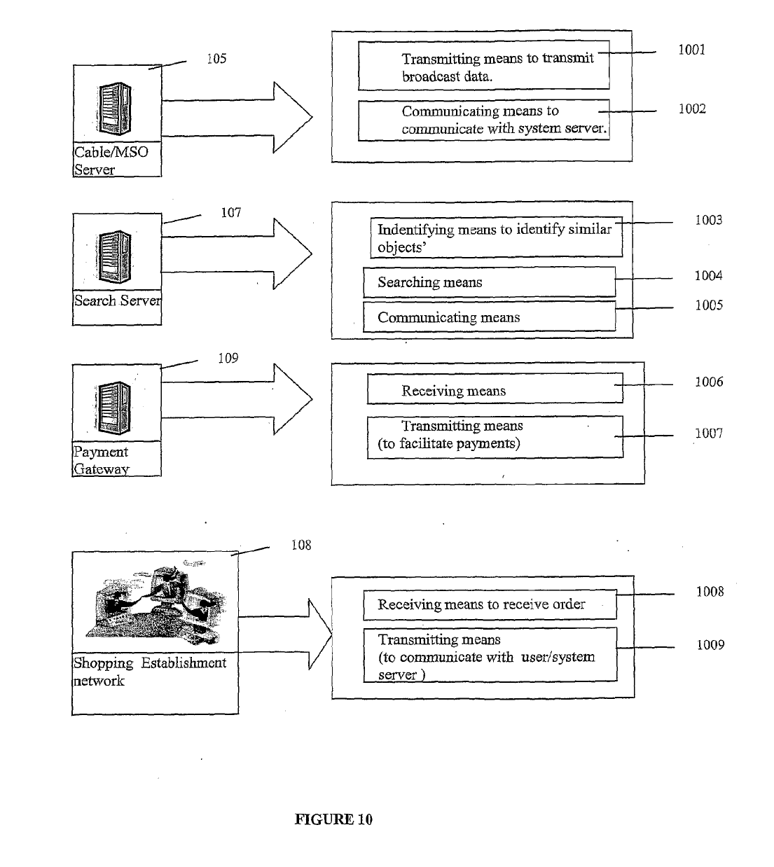

FIG. 10 illustrates the essential elements of a cable/MSO server, search server, payment gateway, shopping establishment network according to a preferred embodiment of the present invention wherein cable/MSO server comprises transmitting means to transmit broadcast data 1001, communicating means to communicate with system server 1002.

Search server comprises identifying means to identify similar objects in comparison to the object selected by the user 1003, searching means to search the object selected by the user 1004, communicating means for an interactive transaction 1005.

Payment gateway comprises receiving means of the information provided by the user 1006, transmitting means to facilitate an interactive payment gateway 1007.

Shopping establishment network comprises receiving means to receive purchase order of the object selected by the user 1008, transmitting means to communicate with the user and/or system server 1009.

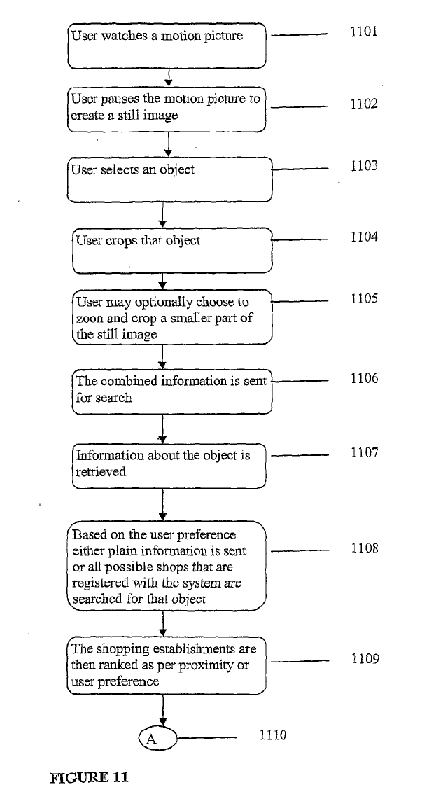

FIG. 11 illustrates the flow diagram of the interactive method to crop, search and shop object as displayed in an electronic media according to a preferred embodiment of the present invention. The method comprises the steps of detecting an interactive visual displayed over an electronic media, selecting the desired visual 1101, pausing the desired visual to create a still image 1102, selecting the desired object as displayed in the still image 1103, cropping the desired object 1104, sending the selected information of the object for search of relevant information 1106, retrieving the relevant information about the searched object 1107, providing the retrieved information in a preferential mode 1108, 1109.

The method optionally provides the user to further zoom and/or crop and/or choose a minor part of the still image so selected 1105.

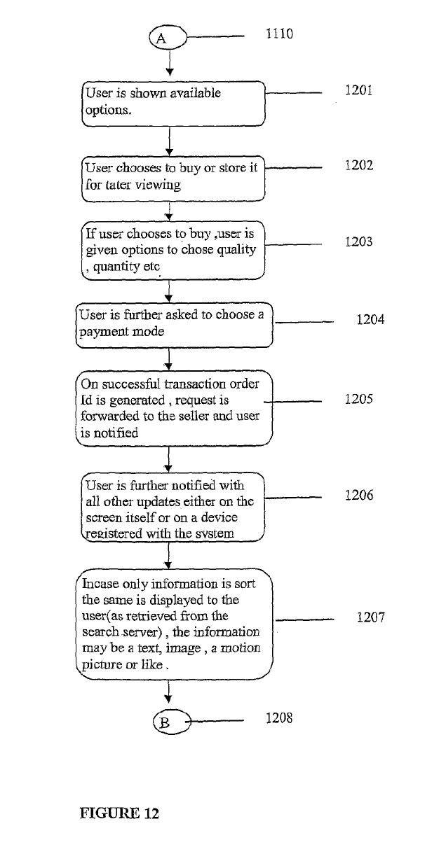

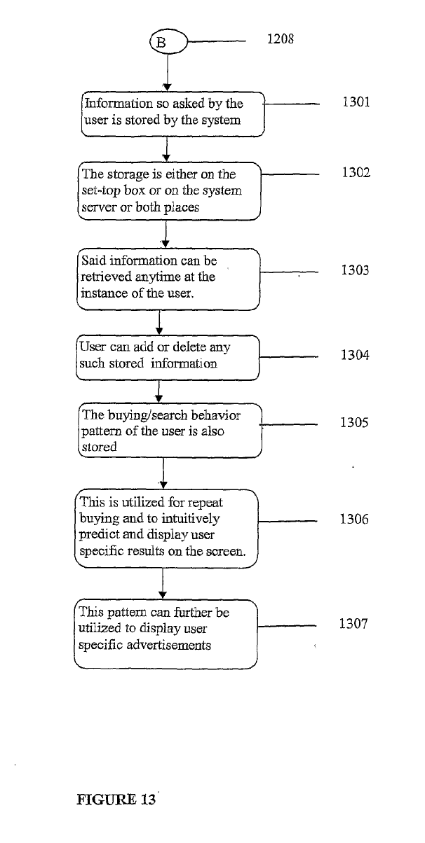

FIGS. 12 and 13 illustrate the flow diagram of the interactive method to crop, search and shop object as displayed in an electronic media according to a preferred embodiment of the present invention. The method comprises the steps of displaying the available retrieved options to the user 1201, providing interactive options to purchase and/or store the selected information for future retrieval 1202, providing options 1202 to ascertain the payment mode if user selects to purchase the desired object 1203, generating a transaction ID and forwarding the purchase order to relevant and/or selected commercial establishment 1205, notifying the user of 1207 all the relevant transaction information on the display screen and/or on a device registered with the system;

The method also provides for the information so asked by the user to be stored by the system 1301, the storage is either on the set-top box or on the system server or both places 1302, said information can be retrieved anytime at the instance of the user 1303, user can add or delete any such stored information 1304, the buying/search behavior pattern of the user is also stored 1305, such information is utilized further future purchase and to intuitively predict and display user specific results on the screen 1306, this pattern can further be utilized to display user specific advertisements 1307.

1. An interactive system to crop, search and shop object as displayed in an electronic media, the system comprising:
an electronic display media;
a remote control device;
a set-top box;
a system server capable to detect a response to an interactive Information received from a user's terminal;
a cable/MSO server and search server coupled to the system server;
a shopping establishment network coupled to the system server;
a payment gateway coupled to the system server.

2. The system as claimed in claim 1, wherein the system server comprises:
receiving and transmitting means to communicate with user set-top box, search server, payment gateway, shopping establishment gateway and the like;
report generating means for transaction information of the selected object; database for storage of information relating to the transaction;
tagging means to identify the object selected by the user;
intuitive means for purchase and/or market prediction;
proximity determination means to provide the relevant information of the commercial establishments having the object selected by the user.

3. The system as claimed in claim 1, wherein cable/MSO server comprises:
transmitting means to transmit broadcast data;
communicating means to communicate with system server.

4. The system as claimed in claim 1, wherein search server comprises:
identifying means to identify similar objects in comparison to the object selected by the user;
searching means to search the object selected by the user;
communicating means for an interactive transaction.

5. The system as claimed in claim 1, wherein payment gateway comprises: receiving means of the information provided by the user;
transmitting means to facilitate an interactive payment gateway.

6. The system as claimed in claim 1, wherein shopping establishment network comprises:
receiving means to receive purchase order of the object selected by the user;
transmitting means to communicate with the user and/or system server.

7. The system as claimed in claim 1, wherein the set-top box comprises:
interpreting means to interpret remote signals;
storage means to store data/information;
searching means for the object selected by the user according to user's preferences;
means to enable recording and store user purchase information and searching pattern;
transmitting means to transmit data/information to system server;
receiving means to receive data/information.

8. The system as claimed in claim 1, wherein the remote control device comprises;
means to pause an image/visual selected by the user;
means to zoom the image/visual selected by the user;
means to choose the image/visual selected by the user;
means to crop the image/visual selected by the user;
user interrupt means to add, delete, store modify and append user's preferences;
user interrupt means to add, delete, store modify information already stored;
means to enable sending/fetching the information for the image/visual selected by the user;
means to retrieve the information of the image/visual selected by the user;
means to initiate the purchase on the basis of the image/visual selected by the user;
means to cancel/continue the purchase according to user's preferences.

9. An interactive method to crop, search and shop object as displayed in an electronic media, the method comprising the steps of:
detecting an interactive visual displayed over an electronic media;
selecting the desired visual;
pausing the desired visual to create a still image;
selecting the desired object as displayed in the still image;
cropping the desired object;
sending the selected information of the object for search of relevant information;
retrieving the relevant information about the searched object;
providing the retrieved information in a preferential mode.

10. The method as claimed in claim 9, further comprising the step of:
providing optional to further zoom and/or crop and/or choose a minor part of the still image.

11. The method as claimed in claim 9, further comprising the step of
amending tags to the cropped image.

12. The method as claimed in claim 9, wherein the retrieved information comprises the relevant general information of the object searched.

13. The method as claimed in claim 9, wherein the retrieved information comprises the information of registered commercial establishments having the object searched.

14. The method as claimed in claim 9, wherein the retrieved information is ranked as per proximity or past user preferences.

15. The method as claimed in claim 9, further comprising the step of:
storing the information for future retrieval.

16. Method as claimed in claim 9, the method further comprising steps of:
displaying the available retrieved options to the user;
providing means to purchase and/or store the selected information for future retrieval;
providing means to ascertain the payment mode if user selects to purchase the desired object;
generating a transaction ID and forwarding the purchase order to relevant and/or selected commercial establishment;
notifying the user of all the relevant transaction information on the display screen and/or on a device registered with the system.

17. The method as claimed in claim 9, wherein retrieved information comprises the information displayed in text mode, image mode, audiovisual mode and/or the like.

18. The method as claimed in claim 9, wherein the method comprises the step of providing an interface to enter a search string/tag for the desired and/or selected object.

19. The method as claimed in claim 9, wherein the sent information comprises the cropped image, tags, previous search history, buying pattern, preferences and combinations thereof.
